(19) United States
(12) Patent Application Publication
(10) Pub. No.: US 2023/0186478 A1
(43) Pub. Date: Jun. 15, 2023

(54) SEGMENT RECOGNITION METHOD, SEGMENT RECOGNITION DEVICE AND PROGRAM

(71) Applicant: NIPPON TELEGRAPH AND TELEPHONE CORPORATION, Tokyo (JP)

(72) Inventors: Yongqing SUN, Musashino-shi, Tokyo (JP); Takashi HOSONO, Musashino-shi, Tokyo (JP)

(73) Assignee: NIPPON TELEGRAPH AND TELEPHONE CORPORATION, Tokyo (JP)

(21) Appl. No.: 17/928,851

(22) PCT Filed: Jun. 5, 2020
(86) PCT No.: PCT/JP2020/022225

§ 371 Date: Nov. 30, 2022

(51) Int. Cl. G06T 7/11; G06T 7/194

(52) U.S. Cl. CPC G06T 7/11; G06T 7/194; G06T 2210/12

(57) ABSTRACT

A segmentation recognition method includes: an object detection step of detecting an object image in a target image by inputting bounding box information including a coordinate and category information of each bounding box defined in the target image to an object detection model that uses a machine learning approach; a filtering step of selecting effective training mask information from training mask information associated with foregrounds in the target image based on the bounding box information; a bounding box branch step of recognizing the object image using weight information of the object detection model as an initial value of weight information of an object recognition model that recognizes an object of the object image; and a mask branch step of generating mask information having a shape of the object image using the selected effective training mask information as training data and using weight information of the object recognition model as an initial value of weight information of a segmentation shape model that segments the target image according to a shape of the object image.

### TECHNICAL FIELD

The present invention relates to a segmentation recognition method, a segmentation recognition device, and a program.

### BACKGROUND ART

Semantic segmentation is a technique for assigning a category to each pixel in a moving image or a still image (recognizing an object in an image). Semantic segmentation has been applied to automatic driving, analysis of medical images, estimation of the state and pose of an object such as a captured person, and the like.

In recent years, techniques for segmenting an image into regions in pixel units using deep learning have been studied actively. Example techniques for segmenting an image into regions in pixel units include a technique called Mask-RCNN (Mask-Regions with Convolutional Neural Networks) (see Non-Patent Literature 1).

FIG. 8 is a diagram showing an example of processing of Mask-RCNN. FIG. 8 shows a target image 100, a CNN 101 (convolutional neural network: CNN), an RPN 102 (region proposal network), a feature map 103, a fixed-size feature map 104, a fully connected layer 105, and a mask branch 106. In FIG. 8, the target image 100 includes a bounding box 200, a bounding box 201, and a bounding box 202.

The CNN 101 is a backbone network based on a convolutional neural network. Bounding boxes in pixel units are input to the CNN 101 as training data for each object category in the target image 100. The detection of the positions of objects in the target image 100 and the assignment of categories in pixel units are performed in parallel in the two branching processes: the fully connected layer 105 and the mask branch 106. In such an approach of supervised segmentation (supervised object shape segmentation), sophisticated training information needs to be prepared in pixel units, so labor and time costs are enormous.

An approach of learning using category information for each object image or region in an image is called weakly supervised segmentation (weakly supervised object shape segmentation). In object shape segmentation using weakly supervised learning, training data (bounding box) is collected for each object image or region, so there is no need to collect training data in pixel units, and labor and time costs are reduced significantly.

An example of weakly supervised segmentation is disclosed in Non-Patent Literature 2. In Non-Patent Literature 2, the foreground and the background in an image are separated by applying MCG (multiscale combinatorial grouping) or Grabcut to category information for each region (bounding box) prepared in advance. The foreground (mask information) is input to an object shape segmentation and recognition network (e.g., Mas-RCNN) as training data. As a result, object shape segmentation (foreground extraction) and object recognition are performed.

### CITATION LIST

### Non-Patent Literature

Non-Patent Literature 1: Kaiming He, Georgia Gkioxari, Piotr Dollar, Ross Girshick, “Mask R-CNN,” ICCV(International Conference on Computer Vision) 2017.

Non-Patent Literature 2: Jifeng Dai, Kaiming He, Jian Sun, “BoxSup: Exploiting Bounding Boxes to Supervise Convolutional Networks for Semantic Segmentation,” ICCV(International Conference on Computer Vision) 2015.

### SUMMARY OF THE INVENTION

### Technical Problem

The quality of mask information input to the neural network as training data (hereinafter referred to as “training mask information”) has a great influence on the performance of weakly supervised segmentation.

For the case where a benchmark data set for object shape segmentation (with bounding box information) is used as target images and existing weakly supervised segmentation using the Grabcut approach is performed to generate training mask information, the quality of the training mask information used for the weakly supervised segmentation was examined. In this examination, about 30% training mask information of the total training mask information was ineffective training mask information, that is, training mask information including no object image (foreground). In addition, the regions of the training masks represented by about 60% training mask information of the ineffective training mask information were small regions of 64×64 pixels or less.

In Non-Patent Literature 2, ineffective mask information generated using the Grabcut approach is used as training data, object shape segmentation and object recognition (assignment of category information) in the images are performed, and thereby the accuracy of object shape segmentation for a small object image and the accuracy of object recognition for a small object image may become low. As described above, conventionally, the accuracy of object shape segmentation for an object image in a target image and the accuracy of object recognition for the object image may be low.

In view of the above circumstances, an object of the present invention is to provide a segmentation recognition method, a segmentation recognition device, and a program capable of improving the accuracy of object shape segmentation for an object image in a target image and the accuracy of object recognition for the object image.

### Means for Solving the Problem

One aspect of the present invention is a segmentation recognition method executed by a segmentation recognition device, the segmentation recognition method including: an object detection step of detecting an object image in a target image by inputting bounding box information including a coordinate and category information of each bounding box defined in the target image to an object detection model that uses a machine learning approach; a filtering step of selecting effective training mask information from training mask information associated with foregrounds in the target image based on the bounding box information; a bounding box branch step of recognizing the object image using weight information of the object detection model as an initial value of weight information of an object recognition model that recognizes an object of the object image; and a mask branch step of generating mask information having a shape of the object image using the selected effective training mask information as training data and using weight information of the object recognition model as an initial value of weight information of a segmentation shape model that segments the target image according to a shape of the object image.

One aspect of the present invention is a segmentation recognition device including: an object detection unit that detects an object image in a target image by inputting bounding box information including a coordinate and category information of each bounding box defined in the target image to an object detection model that uses a machine learning approach; a filtering unit that selects effective training mask information from training mask information associated with foregrounds in the target image based on the bounding box information; a bounding box branch that recognizes the object image using weight information of the object detection model as an initial value of weight information of an object recognition model that recognizes an object of the object image; and a mask branch that generates mask information having a shape of the object image using the selected effective training mask information as training data and using weight information of the object recognition model as an initial value of weight information of a segmentation shape model that segments the target image according to a shape of the object image.

One aspect of the present invention is a program for causing a computer to function as the above-described segmentation recognition device.

### Effects of the Invention

The present invention makes it possible to improve the accuracy of object shape segmentation for an object image in a target image and the accuracy of object recognition for the object image.

### BRIEF DESCRIPTION OF DRAWINGS

FIG. 1 is a diagram showing an example configuration of a segmentation recognition system in an embodiment.

FIG. 2 is a diagram showing an example of processing of a target image in the embodiment.

FIG. 3 is a diagram showing an example configuration of a mask branch in the embodiment.

FIG. 4 is a diagram showing an example operation of the segmentation recognition system in the embodiment.

FIG. 5 is a diagram showing an example operation of a filtering unit in the embodiment.

FIG. 6 is a diagram showing an example operation of a segmentation recognition unit in the embodiment.

FIG. 7 is a diagram showing an example hardware configuration of a segmentation recognition device in the embodiment.

FIG. 8 is a diagram showing an example of processing of Mask-RCNN.

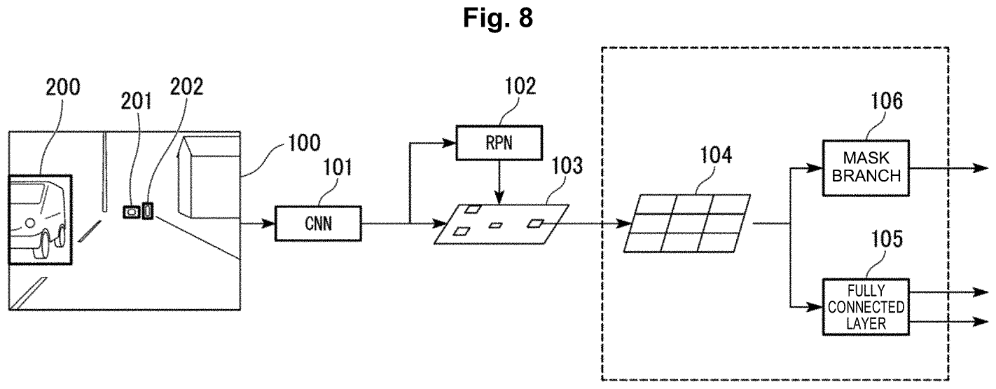

### DESCRIPTION OF EMBODIMENTS

An embodiment of the present invention will be described in detail with reference to the drawings.

(Overview)

In the embodiment, training mask information is divided and effectively used according to the purposes of two tasks of object detection (derivation of a bounding box) and object shape segmentation (generation of mask information having the shape of an object image) in a framework of object shape segmentation and object recognition (assignment of category information to a bounding box). This improves the accuracy of object shape segmentation and the accuracy of object recognition.

That is, in an object detection unit (object detection task) and a bounding box branch (object recognition task), all the bounding box information (the coordinates of each bounding box and category information of each bounding box) is effective information. Therefore, all the bounding box information is used in the object detection task and the object recognition task.

On the other hand, in a mask branch (mask information generation task), ineffective mask information affects the accuracy of object shape segmentation and the accuracy of object recognition. Therefore, filtering processing is performed on one or more weak training data. As a result, selected effective mask information is used in the mask branch.

In the following, the object detection unit uses an image (target image) that is a target of object shape segmentation and object recognition and bounding box information determined in advance in the target image (bounding boxes as predetermined ground-truth regions) to detect object images in the target image.

A filtering unit derives training mask information representing extracted foregrounds using an approach of object shape segmentation (foreground extraction) such as Grabcut that uses the bounding boxes determined in advance in the target image. The filtering unit selects training mask information that is effective (effective training mask information) from the derived training mask information by performing filtering processing on the training mask information.

A segmentation recognition unit performs object shape segmentation and object recognition using the selected effective mask information as training data and using weight information of a neural network of an object detection model learned by a first object detection unit as initial values of object shape segmentation and object recognition. Here, the segmentation recognition unit may transfer the object detection model learned by the first object detection unit to a shape segmentation model and an object recognition model using a transfer learning approach. As a result, the segmentation recognition unit can perform object shape segmentation (generation of mask information) and object recognition on object images with various sizes in the target image.

(Embodiment)

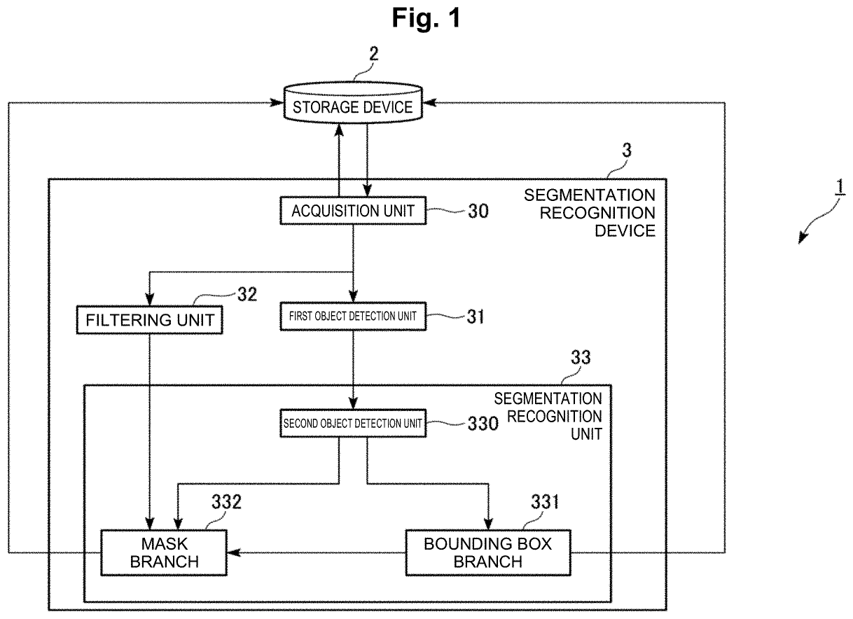

FIG. 1 is a diagram showing an example configuration of a segmentation recognition system 1 in the embodiment. The segmentation recognition system 1 is a system that segments the target image according to the shape of an object image and recognizes the object of the object image (assigns a category to the object image). The segmentation recognition system 1 generates a mask with the shape of the object image and superimposes the mask on the object image in the target image.

The segmentation recognition system 1 includes a storage device 2 and a segmentation recognition device 3. The segmentation recognition device 3 includes an acquisition unit 30, a first object detection unit 31, a filtering unit 32, and a segmentation recognition unit 33. The segmentation recognition unit 33 includes a second object detection unit 330, a bounding box branch 331, and a mask branch 332.

The storage device 2 stores a target image and bounding box information. The bounding box information (weak training data) includes the coordinates and size of each bounding box surrounding each object image in the target image and category information of each bounding box. The category information is, for example, information representing a category of an object such as a robot or a vehicle captured in the target image. When receiving a processing instruction signal from the acquisition unit 30, the storage device 2 outputs the target image and the bounding box information to the acquisition unit 30.

The storage device 2 stores the bounding box information updated by the bounding box branch 331 using an object recognition model. The storage device 2 stores mask information generated by the mask branch 332. The mask information includes the coordinates of a mask image and shape information of the mask image. The shape of the mask image is almost the same as the shape of the object image. The mask image is superimposed on the object image in the target image.

The acquisition unit 30 outputs a processing instruction signal to the storage device 2. The acquisition unit 30 acquires the bounding box information (the coordinates and size of each bounding box and the category information of each bounding box) and the target image from the storage device 2. The acquisition unit 30 outputs the bounding box information as weak training data (bounding boxes as predetermined ground-truth regions) and the target image to the first object detection unit 31 and the filtering unit 32.

The first object detection unit 31 (Faster R-CNN) detects objects in the target image based on the bounding box information and the target image acquired from the acquisition unit 30 using a first object detection model that is based on a convolutional neural network such as “Faster R-CNN” (Reference 1: Faster R-CNN: Towards Real-Time Object Detection with Region Proposal Networks, Shaoqing Ren, Kaiming He, Ross Girshick, Jian Sun, CVPR2015.).

That is, the first object detection unit 31 generates first object detection model information (bounding box information and weight information of the first object detection model) based on the bounding box information and the target image. The first object detection unit 31 outputs the target image and the first object detection model information to the second object detection unit 330.

The filtering unit 32 generates mask information representing foregrounds in the target image based on the bounding box information and the target image acquired from the acquisition unit 30. The shape of a mask image is almost the same as the shape of an object image as a foreground. The filtering unit 32 selects an effective foreground from one or more foregrounds in the target image as an effective mask. The filtering unit 32 outputs the effective mask to the mask branch 332.

The second object detection unit 330 (CNN backbone) acquires the first object detection model information (the bounding box information and the weight information of the first object detection model) and the target image from the first object detection unit 31. The second object detection unit 330 generates a second object detection model by learning weight information of the second object detection model using the weight information of the first object detection model in a fine tuning approach of transfer learning based on the neural network of the first object detection model. The second object detection unit 330 outputs second object detection model information (bounding box information and the weight information of the second object detection model) and the target image to the bounding box branch 331 and the mask branch 332.

The bounding box branch 331 acquires the second object detection model information (the bounding box information and the weight information of the second object detection model) and the target image from the second object detection unit 330. The bounding box branch 331 updates the bounding box information in the target image by learning weight information of the object recognition model based on the target image and the second object detection model information. The bounding box branch 331 records the bounding box information updated using the object recognition model in the storage device 2.

The mask branch 332 acquires the second object detection model information (the bounding box information and the weight information of the second object detection model) and the target image from the second object detection unit 330. The mask branch 332 acquires the effective mask from the filtering unit 32. The mask branch 332 generates mask information having the shape of the object image by learning weight information of a shape segmentation model based on the target image, the effective mask, the second object detection model information (the bounding box information and the weight information of the second object detection model), and the weight information of the object recognition model. The mask branch 332 records the generated mask information in the storage device 2.

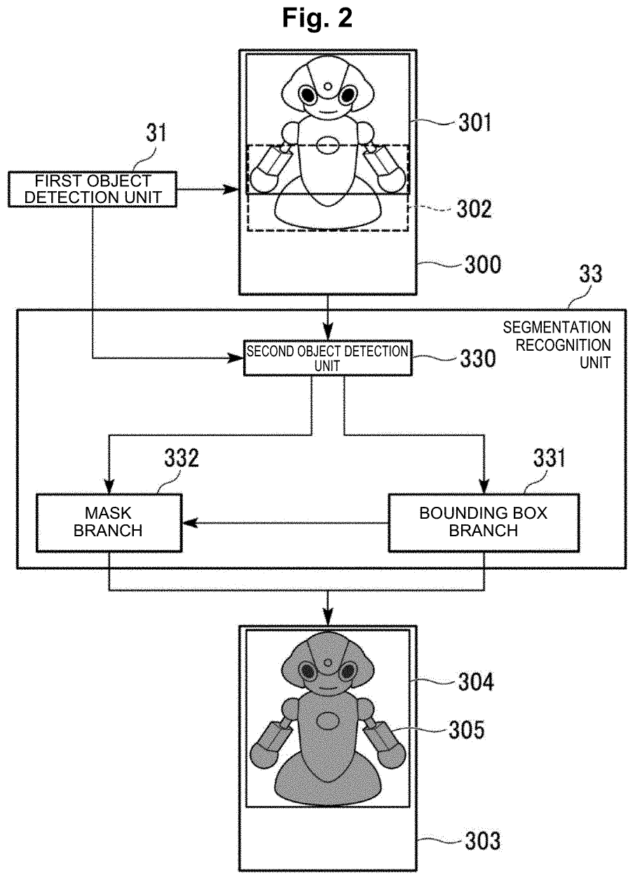

FIG. 2 is a diagram showing an example of processing of a target image in the embodiment. In FIG. 2, a bounding box 301 and a bounding box 302 are defined in a target image 300. The bounding box branch 331 generates a bounding box 304 containing the object image based on the bounding box 301 and the bounding box 302. The mask branch 332 superimposes a generated mask on the object image in the target image 300. The shape of a mask image 305 is almost the same as the shape of the object image.

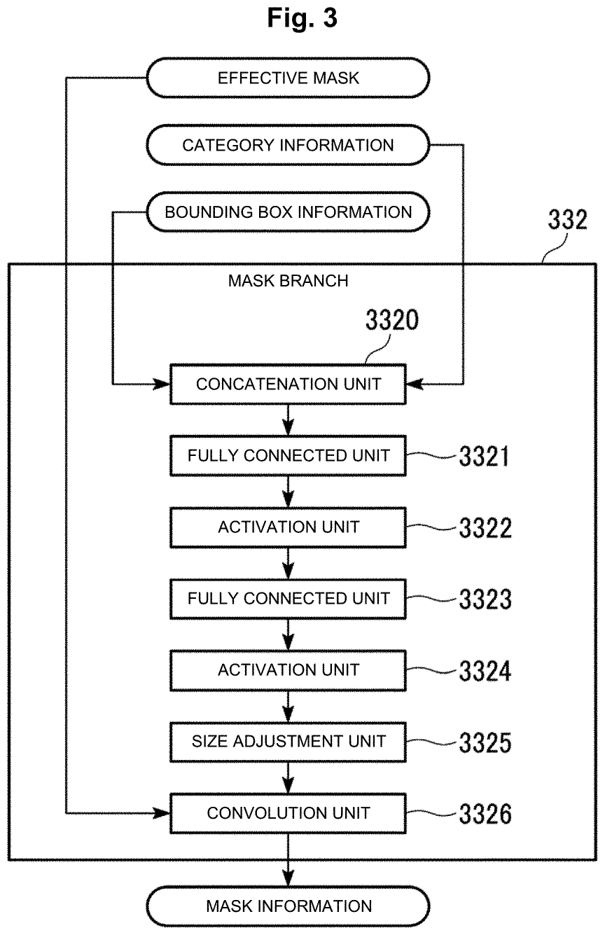

FIG. 3 is a diagram showing an example configuration of the mask branch 332 in the embodiment. The mask branch 332 includes a concatenation unit 3320, a fully connected unit 3321, an activation unit 3322, a fully connected unit 3323, an activation unit 3324, a size adjustment unit 3325, and a convolution unit 3326.

The concatenation unit 3320 acquires the category information (an identification feature and a classification feature) and the bounding box information from the second object detection unit 330. The concatenation unit 3320 concatenates the category information and the bounding box information. The fully connected unit 3321 fully connects the outputs of the concatenation unit 3320. The activation unit 3322 executes the activation function “LeakyReLU” on the outputs of the fully connected unit 3321.

The fully connected unit 3323 fully connects the outputs of the activation unit 3322. The activation unit 3324 executes the activation function “LeakyReLU” on the outputs of the fully connected unit 3323. The size adjustment unit 3325 adjusts the size of the outputs of the activation unit 3324.

The convolution unit 3326 acquires the output of the size adjustment unit 3325. The convolution unit 3326 acquires an effective mask (a segmentation feature) from the filtering unit 32. The convolution unit 3326 generates mask information by performing convolution processing on the output of the activation unit 3324 using the effective mask.

Next, an example operation of the segmentation recognition system 1 will be described.

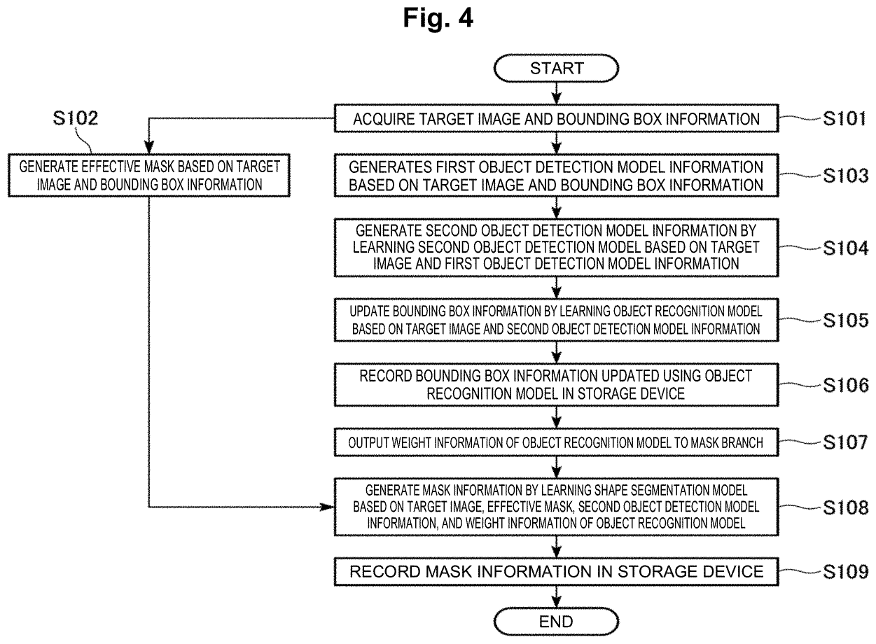

FIG. 4 is a diagram showing an example operation of the segmentation recognition system 1 in the embodiment. The acquisition unit 30 outputs a processing instruction signal to the storage device 2. The acquisition unit 30 acquires the bounding box information (the coordinates of each bounding box and the category information of each bounding box) and the target image from the storage device 2 as a response to the processing instruction signal (step S101).

The filtering unit 32 generates an effective mask based on the target image and the bounding box information. That is, the filtering unit 32 selects an effective foreground from the foregrounds in the target image as an effective mask based on the target image and the bounding box information (step S102). The filtering unit 32 advances the processing to step S108.

The first object detection unit 31 generates the first object detection model information (Faster R-CNN), which is a model for detecting object images in the target image, based on the target image and the bounding box information. The first object detection unit 31 outputs the first object detection model information (the bounding box information and the weight information of the first object detection model) and the target image to the second object detection unit 330 (step S103).

The second object detection unit 330 generates the second object detection model information by learning the weight information of the second object detection model based on the target image and the first object detection model information. The second object detection unit 330 outputs the second object detection model information (the bounding box information and the weight information of the second object detection model) and the target image to the bounding box branch 331 and the mask branch 332 (step S104).

The bounding box branch 331 updates the bounding box information in the target image by learning the weight information of the object recognition model based on the target image and the second object detection model information (step S105).

The bounding box branch 331 records the bounding box information updated using the object recognition model in the storage device 2 (step S106). The bounding box branch 331 outputs the weight information of the object recognition model to the mask branch 332 (step S107).

The mask branch 332 generates the mask information having the shape of the object image by learning the weight information of the shape segmentation model based on the target image, the effective mask, the second object detection model information (the bounding box information and the weight information of the second object detection model), and the weight information of the object recognition model (step S108). The mask branch 332 records the generated mask information in the storage device 2 (step S109).

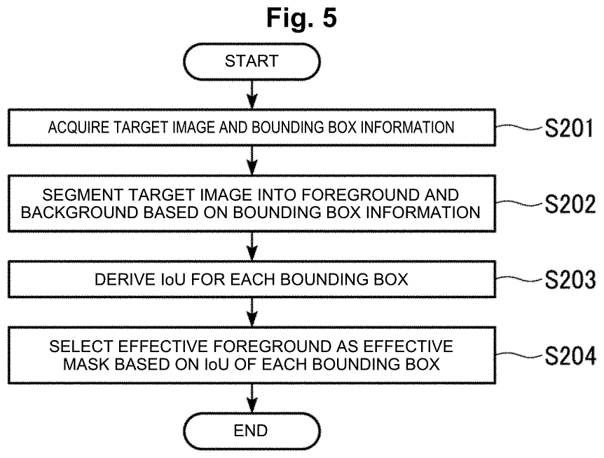

FIG. 5 is a diagram showing an example operation of the filtering unit 32 in the embodiment (details of step S102 shown in FIG. 4). The filtering unit 32 acquires the target image and the bounding box information (bounding boxes as predetermined ground-truth regions) from the acquisition unit 30 (step S201).

The filtering unit 32 segments the target image into the foreground and the background based on the bounding box information (step S202). The filtering unit 32 derives IoU (Intersection over Union) of each bounding box. IoU is one of evaluation indexes in object detection. That is, IoU is the area of the intersection of bounding box information as a predetermined ground-truth region and a bounding box (predicted region) with respect to the area of the union of the bounding box information and the bounding box (predicted region) (step S203). The filtering unit 32 selects an effective foreground (object image) as an effective mask based on IoU of each bounding box (step S204).

For example, the filtering unit 32 selects the foreground in a bounding box with IoU equal to or greater than a first threshold value as an effective mask. The filtering unit 32 may select an effective foreground as an effective mask based on the ratio (filling rate) of the area of the foreground (object image) in the bounding box to the area of the bounding box. For example, the filtering unit 32 selects the foreground in a bounding box with a filling rate equal to or greater than a second threshold value as an effective mask. Further, the filtering unit 32 may select the foreground in a bounding box as an effective mask based on the number of pixels of the bounding box. For example, the filtering unit 32 may select the foreground in a bounding box with the number of pixels equal to or greater than a third threshold value as an effective mask.

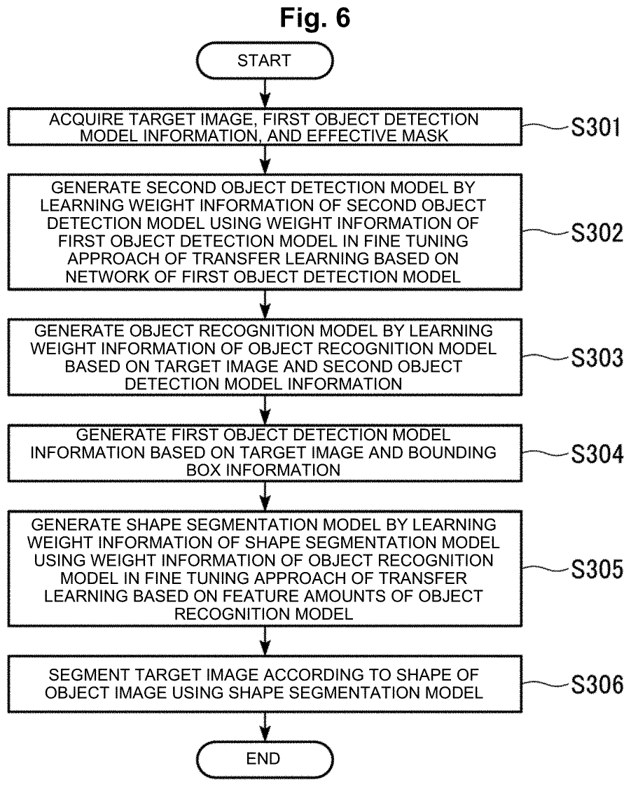

FIG. 6 is a diagram showing an example operation of the segmentation recognition unit 33 in the embodiment. In the segmentation recognition unit 33, the second object detection unit 330 acquires the first object detection model information (the weight information of the first object detection model) and the target image from the first object detection unit 31. The mask branch 332 acquires the effective mask from the filtering unit 32 (step S301).

The second object detection unit 330 generates the second object detection model by learning the weight information of the second object detection model using the weight information of the first object detection model in a fine tuning approach of transfer learning based on the neural network of the first object detection model (step S302).

The bounding box branch 331 generates the object recognition model by learning the weight information of the object recognition model based on the second object detection model information (the weight information of the second object detection model) and the target image (step S303). The bounding box branch 331 updates the bounding box information of the target image using the weight information of the object recognition model (step S304).

The weight information of the object recognition model makes it possible to detect object images with various sizes. On the other hand, in the shape segmentation model in the mask branch 332, a large effective mask is input data. Therefore, at the time of step S304, the shape segmentation model can separate a large object image in the target image, but cannot accurately separate a small object image in the target image.

Therefore, the mask branch 332 generates the shape segmentation model by learning the weight information of the shape segmentation model using the weight information of the object recognition model in a fine tuning approach of transfer learning based on feature amounts of the object recognition model (step S305). The mask branch 332 generates mask information having the shape of the object image by segmenting the target image according to the shape of the object image using the shape segmentation model (step S305).

As described above, the first object detection unit 31 detects an object image in a target image by inputting bounding box information including a coordinate and category information of each bounding box defined in the target image to an object detection model that uses a machine learning approach. The filtering unit 32 selects effective training mask information from training mask information associated with foregrounds in the target image based on the bounding box information. The bounding box branch 331 recognizes the object image using weight information of the object detection model as an initial value of weight information of an object recognition model that recognizes an object of the object image. The mask branch 332 generates mask information having a shape of the object image using the selected effective training mask information as training data and using weight information of the object recognition model as an initial value of weight information of a segmentation shape model that segments the target image according to a shape of the object image.

As described above, the mask information having the shape of the object image is generated using the selected effective training mask information as training data and using the weight information of the object recognition model as the initial values of the weight information of the segmentation shape model. This makes it possible to improve the accuracy of object shape segmentation for an object image in a target image and the accuracy of object recognition for the object image.

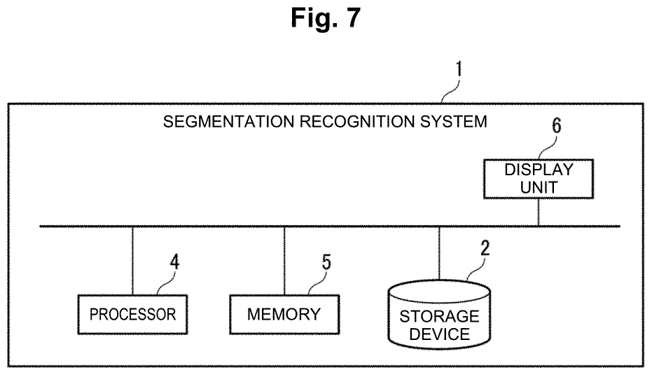

FIG. 7 is a diagram showing an example hardware configuration of the segmentation recognition device in the embodiment. Some or all of the functional units of the segmentation recognition system 1 are implemented as software by a processor 4 such as a CPU (central processing unit) executing a program stored in a storage device 2 having a non-volatile recording medium (non-transitory recording medium) and a memory 5. The program may be recorded on a computer-readable recording medium. A computer-readable recording medium refers to a non-transitory recording medium, for example, a flexible disk, a magneto-optical disk, a ROM (read only memory), a portable medium such as a CD-ROM (compact disc read only memory), and a storage device such as a hard disk built in a computer system. A display unit 6 displays an image.

Some or all of the functional units of the segmentation recognition system 1 may be implemented using hardware including an electronic circuit or circuitry using, for example, an LSI (large scale integration circuit), an ASIC (application specific integrated circuit), a PLD (programmable logic device), or an FPGA (field programmable gate array).

Although an embodiment of the present invention has been described above in detail with reference to the drawings, the specific configuration is not limited to this embodiment, but includes designs and the like within a range not deviating from the gist of the present invention.

### Industrial Applicability

The present invention is applicable to an image processing device.

### REFERENCE SIGNS LIST

1 Segmentation recognition system

2 Storage device

3 Segmentation recognition device

4 Processor

5 Memory

6 Display unit

30 Acquisition unit

31 First object detection unit

32 Filtering unit

33 Segmentation recognition unit

100 Target image

101 CNN

102 RPN

103 Feature map

104 Fixed-size feature map

105 Fully connected layer

106 Mask branch

200 Bounding box

201 Bounding box

202 Bounding box

300 Target image

301 Bounding box

302 Bounding box

303 Target image

304 Bounding box

305 Mask image

330 Second object detection unit

331 Bounding box branch

332 Mask branch

3320 Concatenation unit

3321 Fully connected unit

3322 Activation unit

3323 Fully connected unit

3324 Activation unit

3325 Size adjustment unit

3326 Convolution unit

1. A segmentation recognition method executed by a segmentation recognition device, the segmentation recognition method comprising:
an object detection step of detecting an object image in a target image by inputting bounding box information including a coordinate and category information of each bounding box defined in the target image to an object detection model that uses a machine learning approach;
a filtering step of selecting effective training mask information from training mask information associated with foregrounds in the target image based on the bounding box information;
a bounding box branch step of recognizing the object image using weight information of the object detection model as an initial value of weight information of an object recognition model that recognizes an object of the object image; and
a mask branch step of generating mask information having a shape of the object image using the selected effective training mask information as training data and using weight information of the object recognition model as an initial value of weight information of a segmentation shape model that segments the target image according to a shape of the object image.

2. The segmentation recognition method according to claim 1, wherein
in the mask branch step, weight information of the object recognition model is used as an initial value of weight information of the segmentation shape model based on a transfer learning approach.

3. The segmentation recognition method according to claim 1, wherein
in the filtering step, the effective training mask information is selected based on any one of: the area of the intersection of the bounding box information as a predetermined ground-truth region and the bounding box with respect to the area of the union of the bounding box information and the bounding box; the ratio of the area of a foreground in the bounding box to the area of the bounding box; and the number of pixels of the bounding box.

4. A segmentation recognition device comprising:
an object detection unit that detects an object image in a target image by inputting bounding box information including a coordinate and category information of each bounding box defined in the target image to an object detection model that uses a machine learning approach;
a filtering unit that selects effective training mask information from training mask information associated with foregrounds in the target image based on the bounding box information;
a bounding box branch that recognizes the object image using weight information of the object detection model as an initial value of weight information of an object recognition model that recognizes an object of the object image; and
a mask branch that generates mask information having a shape of the object image using the selected effective training mask information as training data and using weight information of the object recognition model as an initial value of weight information of a segmentation shape model that segments the target image according to a shape of the object image.

5. The segmentation recognition device according to claim 4, wherein
the mask branch uses weight information of the object recognition model as an initial value of weight information of the segmentation shape model based on a transfer learning approach.

6. The segmentation recognition device according to claim 4, wherein
the filtering unit selects the effective training mask information based on any one of: the area of the intersection of the bounding box information as a predetermined ground-truth region and the bounding box with respect to the area of the union of the bounding box information and the bounding box; the ratio of the area of a foreground in the bounding box to the area of the bounding box; and the number of pixels of the bounding box.

7. A non-transitory computer-readable medium having computer-executable instructions that, upon execution of the instructions by a processor of a computer, cause the computer to function as the segmentation recognition device according to claim 1.
